(19) United States
(12) Patent Application Publication
(10) Pub. No.: US 2014/0322065 A1
(43) Pub. Date: Oct. 30, 2014

(54) SOFT MAGNETIC CORE AND MANUFACTURING METHOD OF THE SAME

(71) Applicant: SAMSUNG ELECTRO-MECHANICS CO., LTD., Suwon (KR)

(72) Inventors: Hak Kwan KIM, Suwon (KR); Sung Yong AN, Suwon (KR); No Il PARK, Suwon (KR); Dong Hyeok CHOI, Suwon (KR)

(73) Assignee: SAMSUNG ELECTRO-MECHANICS CO., LTD.

(21) Appl. No.: 13/935,297

(22) Filed: Jul. 3, 2013

(30) Foreign Application Priority Data
Apr. 29, 2013 (KR) 10-2013-0047630

(51) Int. Cl. H01F 1/24; H01F 41/02

(52) U.S. Cl. CPC H01F 1/24; H01F 41/0246
USPC 419/64; 75/232

(57) ABSTRACT

There is provided a soft magnetic core, including: a soft magnetic metal powder; a ferriferous oxide (Fe₃O₄) layer formed on a surface of the soft magnetic metal powder; and an insulating layer formed on the ferriferous oxide (Fe3O4) layer.

### CROSS-REFERENCE TO RELATED APPLICATIONS

This application claims the priority of Korean Patent Application No. 10-2013-0047630 filed on Apr. 29, 2013, in the Korean Intellectual Property Office, the disclosure of which is incorporated herein by reference.

### BACKGROUND OF THE INVENTION

1. Field of the Invention

The present invention relates to a soft magnetic core and a method of manufacturing the same.

2. Description of the Related Art

In general, a soft magnetic material is used for a variety of purposes, such as for a core in an inductor, in a stator and a rotor of an electric device such as a motor, an actuator, a sensor, and a transformer core. Conventionally, such a soft magnetic core, used as a component in an electrical device, has been produced by stacking, fixing and integrating a plurality of processed steel sheets. However, in stacking steel sheets, it is difficult to produce products having relatively complicated three dimensional shapes, and a large amount of material may be lost in the processing thereof.

Recently, a method, in which a soft magnetic powder is molded under high pressure so that core may be produced with higher degree of freedom in terms of shape, has been introduced. Here, the soft magnetic powder refers to a powder having magnetic properties when electricity is applied thereto.

After forming a soft magnetic material into a powder by spraying or grinding, by performing mechanical processing, a heat treatment or the like on the powder, a soft magnetic powder suitable for material for forming a core can be obtained. The soft magnetic powder particles of the powder thus prepared are compression molded so that a soft magnetic core having a desired shape is produced.

### RELATED ART DOCUMENT

(Patent Document 1) Japanese Patent Laid-open Publication No. 2011-233860

### SUMMARY OF THE INVENTION

An aspect of the present invention provides a high-efficiency, high-strength soft magnetic core having low eddy current loss and enhanced mechanical strength, and a manufacturing method of the same.

According to an aspect of the present invention, there is provided a soft magnetic core, including: a soft magnetic metal powder; a ferriferous oxide (Fe₃O₄) layer formed on a surface of the soft magnetic metal powder; and an insulating layer formed on the ferriferous oxide (Fe₃O₄) layer.

The thickness of the ferriferous oxide (Fe₃O₄) layer may be between 50 nm and 700 nm.

The average grain size of the soft magnetic metal powder may be between 50 μm and 200 μm.

The soft magnetic metal powder may be an iron (Fe)-based powder.

The iron (Fe)-based powder may include at least one alloy element of silicon (Si), aluminum (Al), chrome (Cr), molybdenum (Mo), and boron (B).

The thickness of the insulating layer may be between 30 nm and 300 nm.

The insulating layer may include a phosphate compound.

According to another aspect of the present invention, there is provided a manufacturing method of a soft magnetic core, including: preparing a soft magnetic metal powder; forming an insulating layer on the soft magnetic metal powder; preparing slurry containing the soft magnetic metal powder having the insulating layer formed thereon; compression molding the slurry to produce a molded core; and oxidizing a surface of the soft magnetic metal powder contained in the molded core to form a ferriferous oxide (Fe₃O₄) layer.

The forming of the ferriferous oxide (Fe₃O₄) layer may be performed by heat-treating the molded core.

The thickness of the ferriferous oxide (Fe₃O₄) layer may be between 50 nm and 700 nm.

The average grain size of the soft magnetic metal powder may be between 50 μm and 200 μm.

The soft magnetic metal powder may be an iron (Fe))-based powder.

The iron (Fe)-based powder may include at least one alloy element of silicon (Si), aluminum (Al), chrome (Cr), molybdenum (Mo), and boron (B).

The thickness of the insulating layer may be between 30 nm and 300 nm.

The insulating layer may include a phosphate compound.

The manufacturing method may further include, between the forming of the insulating layer and the preparing of the slurry, forming a lubricating wax coating layer on the insulating layer.

The thickness of the lubricating wax coating layer may be between 300 nm and 700 nm.

A melting point of the lubricating wax included in the lubricating wax coating layer may be between 100° C. and 150° C.

The lubricating wax may include at least one of ethylene bis(stearamide) (EBS), Zn-stearate and polyethylene.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a soft magnetic core according to an embodiment of the present invention;

FIG. 2 is a cross-sectional view taken along line A-A′ of FIG. 1;

FIG. 3 is a flow chart illustrating a manufacturing method of a soft magnetic core according to an embodiment of the present invention; and

FIG. 4 is a view sequentially showing processes of manufacturing a soft magnetic core according to an embodiment of the present invention.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

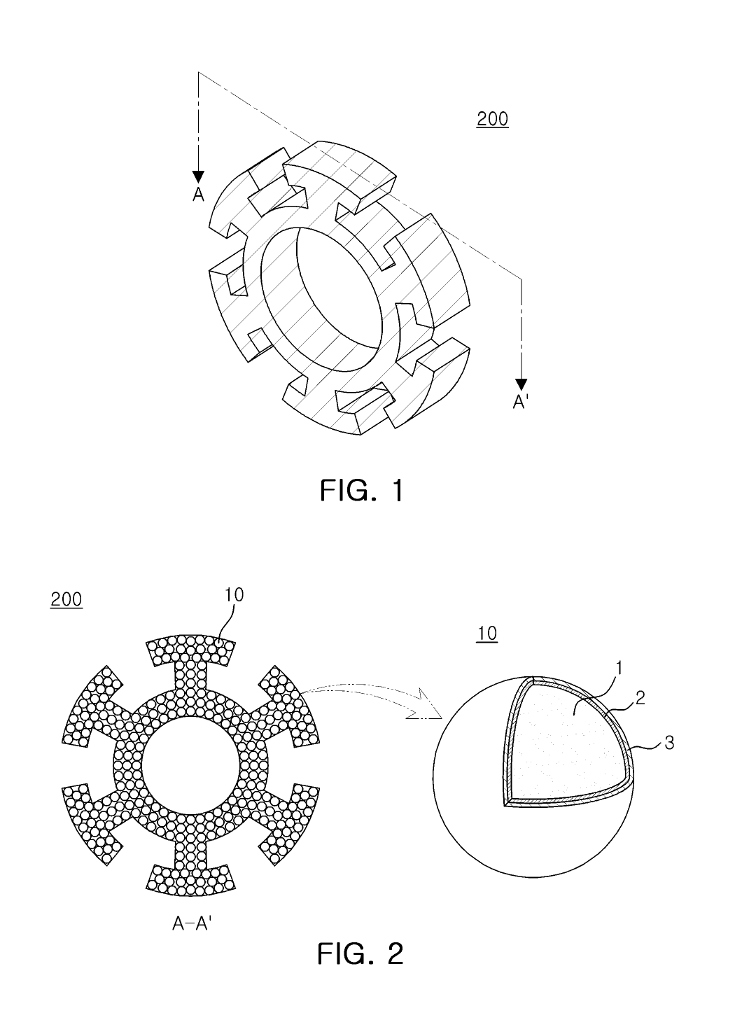

FIG. 1 is a perspective view of a soft magnetic core according to an embodiment of the present invention.

FIG. 2 is a cross-sectional view taken along line A-A′ of FIG. 1.

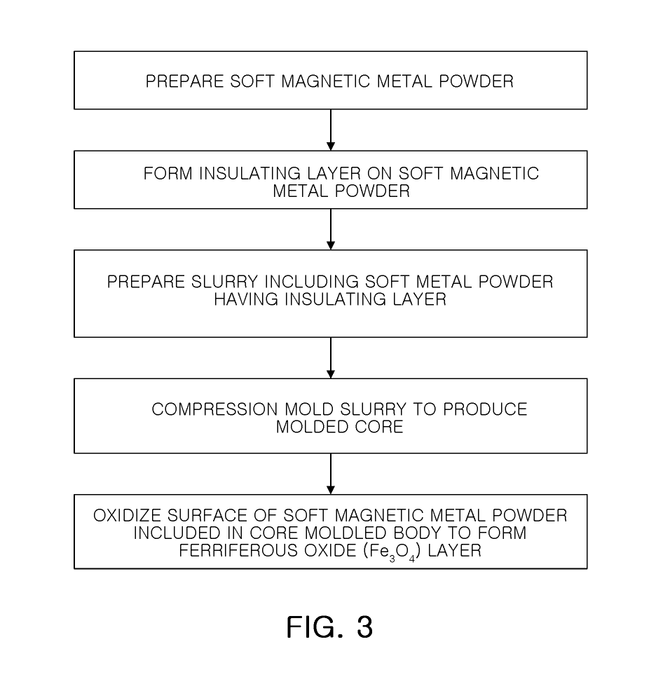

FIG. 3 is a flow chart illustrating a manufacturing method of a soft magnetic core according to an embodiment of the present invention.

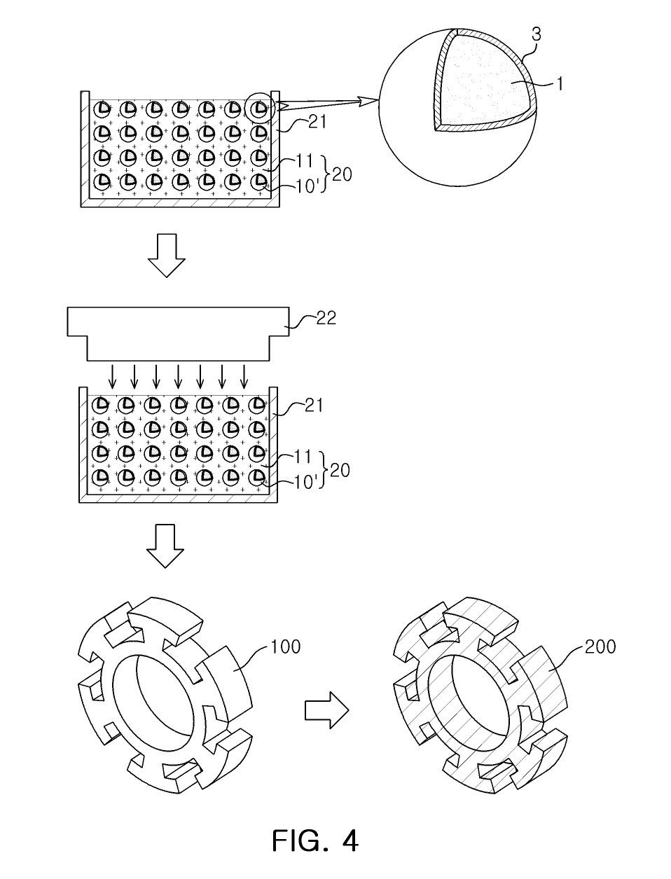

FIG. 4 is a view sequentially showing processes of manufacturing a soft magnetic core according to an embodiment of the present invention.

### Soft Magnetic Core 200

A soft magnetic core 200 according to an embodiment of the present invention will be described with reference to FIGS. 1 and 2.

The soft magnetic core 200 according to the embodiment of the present invention may include a soft magnetic metal powder particle 1, a ferriferous oxide (Fe₃O₄) layer 2, and an insulating layer 3.

That is, the soft magnetic core may include a plurality of soft magnetic complex powder particles 10 having the ferriferous oxide (Fe₃O₄) layer 2 and insulating layer 3 formed on surfaces thereof.

Although the soft magnetic metal powder particle 1 is depicted as having a spherical shape in the drawings for the sake of convenience, the shape thereof is not limited thereto but may have a typical powder particle shape such as an ovoid or polygonal shape.

### (a) Soft Magnetic Metal Powder Particle 1

The soft magnetic metal powder particle 1 included in the soft magnetic core 200 according to the embodiment of the present invention is not specifically limited as long as it has soft magnetic properties.

The average grain size of the soft magnetic metal powder particle 1 may be between 50 μm and 200 μm. If the average grain size of the soft magnetic metal powder particle 1 is below 50 μm, the magnetic flux density of the soft magnetic core may be reduced. If the average grain size of the soft magnetic metal powder particle 1 is above 200 μM, although the magnetic flux density is increased, core loss increases, and in particular, eddy current loss drastically increases, which causes a problem at high frequency. Accordingly, it is desired that the soft magnetic metal powder particle 1 has the average grain size between 50 μm and 200 μm.

The soft magnetic metal powder particle 1 may be formed of pure iron or an iron (Fe)-based alloy.

Technically, pure iron refers to iron having a purity of 100% with no impurities contained therein. However, since it is difficult to completely remove impurities such as carbon, nitrogen, silicon, phosphorus, and sulfur from pig iron, pure iron commonly refers to iron having a higher purity than other iron, and the term is used in the same sense herein.

The iron (Fe)-based alloy is made of iron (Fe) and at least one other alloy element, and has the properties of metal. The alloy element is not specifically limited, as long as it increases electric resistance, and may include at least one of silicon (Si), aluminum (Al), chrome (Cr), molybdenum (Mo), and boron (B).

Among others, silicon (Si), aluminum (Al), chrome (Cr), molybdenum (Mo), and boron (B) have excellent effects in increasing resistance.

### (b) Ferriferous Oxide (Fe₃O₄) Layer 2

On the surface of the soft magnetic metal powder particle 1, a ferriferous oxide (Fe₃O₄) layer 2 may be formed. By virtue of the ferriferous oxide (Fe₃O₄) layer 2, the bonding force between the insulating layer 3 and the soft magnetic metal powder particle 1 may be enhanced, and corrosion resistance, abrasion resistance and yield stress may be increased.

Unlike Fe₂O₃, Fe₃O₄ has Fe²⁺ and Fe³⁺ in a 1:1 ratio so that it has improved magnetic properties, as compared to α-Fe₂O₃ which has Fe3+ only. Accordingly, employing Fe₃O₄ in molding the core is advantageous in terms of permeability, compared to employing conventional Fe₂O₃.

The thickness of the ferriferous oxide (Fe₃O₄) layer 2 may be between 50 nm and 700 nm. If the thickness of the ferriferous oxide (Fe₃O₄) layer 2 is below 50 nm, an enhancement of bonding force between the insulating layer and the powder is not sufficiently obtained, and cracks may be generated in the ferriferous oxide (Fe₃O₄) layer 2 so that tunneling may occur.

If the thickness of the ferriferous oxide (Fe₃O₄) layer 2 is above 700 nm, the overall magnetic flux density of the core is decreased because the portion of the ferriferous oxide (Fe₃O₄) layer 2 relative to the soft magnetic metal powder may become too large, whereas the effect of enhancement in yield stress of the soft magnetic core is saturated and thus no further increased.

### (c) Insulating Layer 3

On the ferriferous oxide (Fe₃O₄) layer 2 formed on the surface of the soft magnetic metal powder particle 1, the insulating layer 3 may be formed.

The insulating layer 3 serves to electrically insulate the magnetic metal powder particles 1 so as to reduce eddy current loss, and may include, but are not limited to, a phosphate compound, an epoxy resin, and a ceramic.

Moreover, the insulating layer 3 may have a thickness between 30 nm and 300 nm. If the thickness of the insulating layer is above 300 nm, the magnetic flux density of the core may be decreased. If the thickness of the insulating layer is below 30 nm, insulation may be insufficient, so that core loss is increased. Moreover, cracks may occur during a compression molding process, such that tunneling may be generated, thereby further deteriorating insulation properties.

### Manufacturing Method of Soft Magnetic Core 200

In the following, a manufacturing method of a soft magnetic core 200 according to an embodiment of the present invention will be described with reference to FIGS. 3 and 4.

In describing a manufacturing method of the soft magnetic core, redundant descriptions with respect to the above-described soft magnetic core 200 will be omitted.

The manufacturing method of a soft magnetic core according to an embodiment of the present invention includes: preparing a soft magnetic metal powder particle 1; forming an insulating layer 3; preparing a slurry 20; manufacturing a molded core 100; and forming a ferriferous oxide (Fe₃O₄) layer 2.

Further, the method may further include forming a lubricating wax coating layer (not shown) on the insulating layer 3, after the forming of the insulating layer 3 and before preparing the slurry 20.

### (1) Preparing Soft Magnetic Metal Powder Particle 1 Having Insulating Layer 3 Formed Thereon

Initially, a soft magnetic metal powder particle 1 is prepared, and then an insulating layer 3 is formed on the soft magnetic metal powder. As described above, the insulating layer may include, but is not limited to, a phosphate compound, an epoxy resin, and a ceramic.

### (2) Preparing the Slurry 20

Subsequently, the slurry 20 including the soft magnetic metal powder particle 1 having the insulating layer 3 thereon is produced. The slurry may include the soft magnetic metal powder particle 1 having the insulating layer 3 formed thereon and an additive 11. The additive may include, but is not limited to, a binder, a solvent or the like.

The binder may be, but is not limited to, at least one selected from a group consisting of water glass, a polyimide, a polyamide, silicon, a phenol resin, and acryl.

In addition, a volatile solvent may be added in order to adjust viscosity of the slurry 20. The volatile solvent may include, but is not limited to, at least one of toluene, alcohol, and methyl ethyl ketone (MEK).

### (3) Manufacturing Molded Core 100

A soft magnetic core mold 100 having a desired core shape is produced using the slurry 20. This may include, but is not limited to, injecting the slurry 20 into a molding 21 having a core shape and then compression molding it using a presser 22.

### (4) Heat Treatment

Subsequently, the soft magnetic molded core 100 is subjected to heat treatment, such that a ferriferous oxide (Fe₃O₄) layer 2 is formed between the soft magnetic metal powder particle 1 and the insulating layer 3. Further, a ferriferous oxide (Fe₃O₄) layer 2 may be formed on the surface of the soft magnetic molded core produced through the heat treatment.

The ferriferous oxide (Fe₃O₄) layer 2 formed on the surface of the soft magnetic metal powder may enhance the bonding force between the soft magnetic metal powder and the insulating layer, and the ferriferous oxide (Fe₃O₄) layer 2 formed on the surface of the soft magnetic core molded article may increase corrosion resistance, abrasion resistance and yield stress of the soft magnetic core itself.

### (5) Forming Lubricating Wax Coating Layer 3 for Lubrication

After the forming of the insulating layer and before the preparing of the slurry, the method may further include forming a lubricating wax coating layer (not shown) on the insulating layer 3. By forming the lubricating wax coating layer on the powder, the frictional force between the soft magnetic complex powder particles or between the soft magnetic complex powder and the mold wall may be minimized. That is, in molding a core with the soft magnetic metal powder having the wax coating layer formed on the insulating layer 3, during a warm pressing in which powder particles are in contact with one another and crushed by external pressure, the lubricating wax changes from a solid state to a liquid state, thereby reducing frictional force, such that residual stress generated due to the compression molding is reduced and hysteresis loss is reduced. Ultimately, a core having lower core loss may be obtained.

Conventionally, molding has been performed by mixing lubrication powder particles on the scale of several μm with soft magnetic metal powder particles. However, in the case that the lubrication powder particles are not uniformly mixed, hysteresis loss is increased in the area in which the lubrication powder particles are not present in high amounts so that frictional force is greater, whereas magnetic properties are deteriorated in areas in which too many lubrication powder particles are present, so that actual carbon increases. Accordingly, as taught by the present invention, the above shortcoming may be overcome by coating lubricating wax on the insulating layer 3 of the soft magnetic metal powder particle 1.

The forming of the lubricating wax coating layer may include, but is not limited to, melting the wax for lubrication into a liquid state and then dipping the soft magnetic metal powder particle 1 having the insulating layer 3 thereon into the wax for lubrication, or spraying lubricating wax in a liquid state on the insulating layer 3 formed on the surface of the soft magnetic metal powder particle 1 and then drying the wax thereon.

The lubricating wax for the lubricating wax coating layer has a melting point between 100° C. and 150° C. This is because the molding temperature is often above 80° C. in molding a core using the soft magnetic metal powder. Further, if the melting point of the lubricating wax exceeds 150° C., the lubricating wax does not change into a liquid state at a molding temperature so that the effect of reducing the frictional force between the powder particles or between the powder and the molding is significantly reduced.

The lubricating wax may include at least one of ethylene bis (stearamide) (EBS), Zn-stearate and polyethylene.

The melting point of the ethylene bis (stearamide) (EBS) is between about 141° C. and 146° C., the melting point of Zn-stearate is between about 121° C. and 124° C., and the melting point of polyethylene is between about 100° C. and 110° C.

The lubricating wax coating layer may have a thickness of between 300 nm and 700 nm. If the thickness of the lubricating wax coating layer is below 300 nm, during a compression molding process, the melted lubricating wax may fail to sufficiently cover the powder particles to reduce friction between powder particles or between the powder and the molding, such that an insulating film may be damaged and core loss thus increased. Further, if the thickness of the lubricating wax is above 700 nm, the portion of the magnetic material in a core is reduced and thus molding density and flux density are reduced, such that core loss is increased again. Therefore, it is desired that the lubricating wax coating layer may have a thickness between 300 nm and 700 nm.

### Example

Table 1 below represents physical properties according to thicknesses of the ferriferous oxide (Fe₃O₄) layer of the soft magnetic complex powder in the soft magnetic core.

The soft magnetic complex metal powder used in manufacturing the soft magnetic core of the example includes an iron-based power having D50=170 μm, an insulating layer including a phosphate compound and having a thickness of 150 nm, and a lubricating wax coating layer having a thickness of 400 nm.

TABLE 1

| | Thickness of | | Magnetic flux | Yield |
|---|---|---|---|---|
| | ferriferous oxide | Permeability | density | stress |
| sample | (Fe₃O₄) layer (nm) | (H/m) | (T) | (MPa) |
| 1* | 0 | 480 | 1.58 | 90 |
| 2 | 50 | 600 | 1.6 | 140 |
| 3 | 100 | 610 | 1.62 | 200 |
| 4 | 200 | 630 | 1.63 | 250 |
| 5 | 300 | 650 | 1.62 | 300 |
| 6 | 400 | 660 | 1.66 | 450 |
| 7 | 500 | 700 | 1.7 | 500 |
| 8 | 700 | 700 | 1.67 | 500 |
| 9* | 900 | 690 | 1.55 | 480 |
| 10* | 1000 | 620 | 1.53 | 470 |

*denotes a comparative example.

As can be seen from the example, as the thickness of the ferriferous oxide layer increases, the permeability, the magnetic flux density, and the yield stress tended to be increased. It is considered that this results from the fact that the ferriferous oxide layer is formed between the iron-based powder and the insulating layer after heat treatment, such that the bonding strength therebetween is increased and ultimately the yield stress of the core is enhanced. It can also be seen, however, that once the thickness of the ferriferous oxide layer reaches 700 nm, i.e., the threshold, the yield strength as well as the permeability and the magnetic flux density are not increased but saturated, and thereafter it have negative effects.

Further, although not provided as experimental data, when the thickness of the ferriferous oxide layer is below 50 nm, tunneling occurs, as described above.

Therefore, it is desirable that the thickness of the ferriferous oxide layer be between 50 nm and 700 nm.

According to the embodiment of the present invention, by forming the ferriferous oxide (Fe₃O₄) layer on the surface of the soft magnetic metal powder and the surface of the soft magnetic core, the soft magnetic core having excellent bonding force between the soft magnetic metal powder and the insulating layer and having enhanced corrosion resistance, abrasion resistance and yield stress, and a manufacturing method thereof can be provided.

As set forth above, according to the embodiments of the present invention, a high-efficiency, high-strength soft magnetic core having low eddy current loss and enhanced mechanical strength and a manufacturing method of the same are provided.

While the present invention has been shown and described in connection with the embodiments, it will be apparent to those skilled in the art that modifications and variations can be made without departing from the spirit and scope of the invention as defined by the appended claims.

What is claimed is:

1. A soft magnetic core, comprising:
a soft magnetic metal powder;
a ferriferous oxide (Fe₃O₄) layer formed on a surface of the soft magnetic metal powder; and
an insulating layer formed on the ferriferous oxide (Fe₃O₄) layer.

2. The soft magnetic core of claim 1, wherein a thickness of the ferriferous oxide (Fe₃O₄) layer is between 50 nm and 700 nm.

3. The soft magnetic core of claim 1, wherein a average grain size of the soft magnetic metal powder is between 50 μm and 200 μm.

4. The soft magnetic core of claim 1, wherein the soft magnetic metal powder is an iron (Fe)-based powder.

5. The soft magnetic core of claim 4, wherein the iron (Fe))-based powder includes at least one alloy element of silicon (Si), aluminum (Al), chrome (Cr), molybdenum (Mo), and boron (B).

6. The soft magnetic core of claim 1, wherein a thickness of the insulating layer is between 30 nm and 300 nm.

7. The soft magnetic core of claim 1, wherein the insulating layer includes a phosphate compound.

8. A manufacturing method of a soft magnetic core, comprising:
preparing a soft magnetic metal powder;
forming an insulating layer on the soft magnetic metal powder;
preparing slurry containing the soft magnetic metal powder having the insulating layer formed thereon;
compression molding the slurry to produce a molded core; and
oxidizing a surface of the soft magnetic metal powder contained in the molded core to form a ferriferous oxide (Fe₃O₄) layer.

9. The method of claim 8, wherein the forming of the ferriferous oxide (Fe₃O₄) layer is performed by heat-treating the molded core.

10. The method of claim 8, wherein a thickness of the ferriferous oxide (Fe₃O₄) layer is between 50 nm and 700 nm.

11. The method of claim 8, wherein a average grain size of the soft magnetic metal powder is between 50 μM and 200 μM.

12. The method of claim 8, wherein the soft magnetic metal powder is an iron (Fe)-based powder.

13. The method of claim 12, wherein the iron (Fe)-based powder includes at least one alloy element of silicon (Si), aluminum (Al), chrome (Cr), molybdenum (Mo), and boron (B).

14. The method of claim 8, wherein a thickness of the insulating layer is between 30 nm and 300 nm.

15. The method of claim 8, wherein the insulating layer includes a phosphate compound.

16. The method of claim 8, further comprising, between the forming of the insulating layer and the preparing of the slurry, forming a lubricating wax coating layer on the insulating layer.

17. The method of claim 16, wherein a thickness of the lubricating wax coating layer is between 300 nm and 700 nm.

18. The method of claim 16, wherein a melting point of lubricating wax included in the lubricating wax coating layer is between 100° C. and 150° C.

19. The method of claim 16, wherein the lubricating wax includes at least one of ethylene bis(stearamide) (EBS), Zn-stearate and polyethylene.
